(19) United States
(12) Patent Application Publication
(10) Pub. No.: US 2016/0245239 A1
(43) Pub. Date: Aug. 25, 2016

(54) Apparatus And Methods For Exhaust Gas Recirculation For An Internal Combustion Engine Utilizing At Least Two Hydrocarbon Fuels

(71) Applicant: Southwest Research Institute, San Antonio, TX (US)

(72) Inventor: Cary A. HENRY, Helotes, TX (US)

(21) Appl. No.: 14/631,384

(22) Filed: Feb. 25, 2015

(51) Int. Cl. F02M 26/35; F02M 26/20; F02M 43/04; F02M 37/00; F02M 61/14; F01N 3/20; F02M 26/36

(52) U.S. Cl. CPC F02M 26/35; F01N 3/20; F02M 26/20; F02M 26/36; F02M 37/0076; F02M 61/145; F02M 43/04

(57) ABSTRACT

A method of operating an internal combustion engine having a plurality of cylinders, the method comprising: operating the engine with at least one of the cylinders of the engine as a dedicated exhaust gas recirculation (EGR) cylinder; mixing exhaust gas expelled from the dedicate EGR cylinder with air in an intake system to provide a mixture of exhaust gas and air; providing a first hydrocarbon fuel and a second hydrocarbon fuel; introducing a charge comprising the first hydrocarbon fuel, the second hydrocarbon fuel and the mixture of exhaust gas and air to the dedicated EGR cylinder; igniting the charge in the dedicated EGR cylinder; expelling exhaust gas from the dedicated EGR cylinder; and recirculating the exhaust gas to the intake system of the engine.

### FIELD

The present disclosure relates to exhaust gas recirculation for internal combustion engines, and more particularly, to improved exhaust gas recirculation for internal combustion engines powered by hydrocarbon (HC) fuels.

### BACKGROUND

For certain conventional exhaust gas recirculation (EGR) systems, exhaust gas expelled from all of the cylinders of an internal combustion engine may be collected in an exhaust manifold. A fraction of the collected exhaust gas (e.g. 5% to 10%) may then be routed from the exhaust manifold through a control valve back to an intake manifold of the engine, where it may be introduced to a stream of fresh (ambient) intake air. The remaining fraction of exhaust gas in the exhaust manifold, rather than being recirculated and recycled, generally flows to a catalytic converter of the exhaust system and, after treatment therein, may be expelled to the atmosphere through the exhaust pipe.

EGR has a history of use in gasoline spark-ignition engines, and affects combustion in several ways. First, the combustion in the cylinders of the engine may be cooled by the presence of exhaust gas, that is, the recirculated exhaust gas may absorb heat from the combustion. Furthermore, the dilution of the oxygen present in the combustion chamber with the exhaust gas, in combination with the cooler combustion, may reduce the production of mono-nitrogen oxides (NOx), such as nitric oxide (NO) and nitrogen dioxide (NO₂). Additionally, EGR may reduce the need for fuel enrichment at high loads in turbocharged engines and thereby improve fuel economy.

EGR which uses higher levels of exhaust gas may further increase fuel efficiency and reduce emissions of spark-ignition engines. However, with higher levels of exhaust gas, engines may face challenges related to EGR tolerance, which may reduce the expected fuel efficiency improvement. Challenges related to EGR tolerance may be understood to include increasing an engine's ability to process higher levels of exhaust gas without adversely affecting performance, particularly fuel economy. Thus, even if EGR tolerance may be satisfactory for engine operation at low levels of EGR, an engine may need additional modifications in structure and operational conditions to accommodate higher levels of EGR without adversely affecting engine performance.

More recently, an engine configuration has been proposed with one or more cylinders of the engine being dedicated to expelling exhaust gas for EGR, which is then directed to the intake manifold. Such cylinders may be referred to as dedicated EGR, or D-EGR, cylinders. Dedicated EGR cylinder(s) may operate at a broad range of equivalence ratios since their exhaust gas is generally not configured to exit the engine before flowing through a cylinder operating at, for example, a stoichiometric or near stoichiometric air/fuel ratio. This may allow the dedicated EGR cylinder to be operated fuel rich to produce higher levels of hydrogen (H₂) gas and carbon monoxide (CO) gas and which, may in turn, increase the octane number and promote increased EGR tolerance and knock tolerance by increasing flame/speed burn rates, as well as increasing the dilution limits of the mixture and associated combustion stability of all the cylinders. Examples of engines with a D-EGR cylinder may be found in U.S. Patent Application Publication No. 2012/0204844 entitled “Dedicated EGR Control Strategy For Improved EGR Distribution And Engine Performance” and U.S. Patent Application Publication No. 2012/0204845 entitled “EGR Distributor Apparatus For Dedicated EGR Configuration”, both in the name of Jess W. Gingrich, which are assigned to the assignee of the present disclosure and hereby incorporated by reference.

### SUMMARY

The present disclosure provides various apparatus and methods for treatment of exhaust gas for recirculation in an internal combustion engine which utilizes at least two hydrocarbon fuels, which may be particularly applied to an engine having at least one dedicated exhaust gas recirculation (EGR) cylinder. This disclosure exploits the benefits of different fuel technologies to provide synergistic characteristics not possible with a single fuel. More particularly, by utilizing a primary combustion fuel, such as gasoline, in all the cylinders (including the dedicated EGR cylinder), the rich limit of combustion may be extended, combustion duration may be decreased, and the ignition energy requirement may be reduced. Coupling the injection of the primary fuel in the dedicated (EGR) cylinder with a secondary fuel having a hydrogen to carbon (H:C) atomic ratio which is greater than that of the primary fuel, such as compressed natural gas (CNG), liquefied natural gas (LNG) or liquefied petroleum gas (LPG), provides increased levels of hydrogen (H₂) gas in the recirculated exhaust gas which lead to further improvements in fuel efficiency in the engine.

In at least one embodiment, a method of operating an internal combustion engine having a plurality of cylinders is provided, with the method comprising: operating the engine with at least one of the cylinders of the engine as a dedicated exhaust gas recirculation (EGR) cylinder, wherein 90%-100% by volume of exhaust gas expelled from the dedicated EGR cylinder is recirculated to an intake system of the engine; mixing exhaust gas expelled from the dedicate EGR cylinder with air in the intake system of the engine to provide a mixture of exhaust gas and air; providing a first hydrocarbon fuel from a first fuel tank; providing a second hydrocarbon fuel from a second fuel tank; introducing a charge comprising the first hydrocarbon fuel, the second hydrocarbon fuel and the mixture of exhaust gas and air to the dedicated EGR cylinder; igniting the charge in the dedicated EGR cylinder; expelling exhaust gas from the dedicated EGR cylinder; and recirculating the exhaust gas to the intake system of the engine.

In at least one embodiment, the second hydrocarbon fuel has a hydrogen to carbon (H:C) atomic ratio greater than the first hydrocarbon fuel.

In at least one embodiment, the first hydrocarbon fuel is gasoline, and the second hydrocarbon fuel is natural gas or is liquefied petroleum gas.

In at least one embodiment, the second hydrocarbon fuel is added to the mixture of exhaust gas and air provided to the dedicated EGR cylinder by a fuel injector located in an intake manifold of the engine or intake port of the engine.

In at least one embodiment, the method may further comprise introducing a charge comprising the first hydrocarbon fuel and the mixture of exhaust gas and air to each of the remaining cylinders, and wherein the charge introduced to each of the remaining cylinders does not include the second hydrocarbon fuel.

In at least one embodiment, the method may further comprise igniting the charge in each of the remaining cylinders; expelling exhaust gas from each of the remaining cylinders; and treating the exhaust gas expelled from each of the remaining cylinders with a catalytic converter.

In at least one embodiment, during the step of recirculating the exhaust gas to the intake system of the engine, the exhaust gas is routed through a water gas shift reactor; and the exhaust gas undergoes a reaction in the water gas shift reactor, wherein the reaction increases a quantity of hydrogen contained in the exhaust gas.

In at least one embodiment, during the step of recirculating the exhaust gas to the intake system of the engine, the exhaust gas is routed through a steam hydrocarbon reformer; and the exhaust gas undergoes a reaction in the steam hydrocarbon reformer, wherein the reaction increases a quantity of carbon monoxide and hydrogen contained in the exhaust gas.

In at least one embodiment, a motor vehicle is provided, with the motor vehicle comprising an internal combustion engine having a plurality of cylinders; at least one of the cylinders of the engine arranged as a dedicated exhaust gas recirculation (EGR) cylinder, wherein 90%-100% by volume of exhaust gas expelled from the dedicated EGR cylinder is recirculated to an intake system of the engine; a plurality of first fuel injectors to receive a first hydrocarbon fuel from a first fuel tank of the motor vehicle, wherein each of first fuel injectors is arranged to provide the first hydrocarbon fuel to one of each of the cylinders; and a second fuel injector to receive a second hydrocarbon fuel from a second fuel tank of the motor vehicle, wherein the second fuel injector is arranged to provide the second hydrocarbon fuel to the dedicated EGR cylinder.

In at least one embodiment, the engine is arranged such that the second hydrocarbon fuel is only provided to the dedicated EGR cylinder and not the remaining cylinders.

In at least one embodiment, the exhaust gas expelled from the dedicated EGR cylinder is recirculated to the intake system of the engine in an EGR feedback loop; and the engine further comprises a water gas shift reactor located in the EGR feedback loop such that the exhaust gas expelled from the dedicate EGR cylinder is routed through the water gas shift reactor.

In at least one embodiment, the exhaust gas expelled from the dedicated EGR cylinder is recirculated to the intake system of the engine in an EGR feedback loop; and the engine further comprises a steam hydrocarbon reformer located in the EGR feedback loop such that the exhaust gas expelled from the dedicated EGR cylinder is routed through the steam hydrocarbon reformer.

In at least one embodiment, the first fuel injectors are arranged to direct the first fuel directly into each cylinder.

In at least one embodiment, the second fuel injector is arranged in an intake port of the dedicated EGR cylinder or an intake passage of the dedicated EGR cylinder.

In at least one embodiment, the intake port is within a cylinder head of the engine.

In at least one embodiment, the intake passage is located within an intake manifold of the engine.

In at least one embodiment, the first fuel tank is a gasoline fuel tank and the second fuel tank is a natural gas fuel tank or a liquefied petroleum gas fuel tank.

In at least one embodiment, an engine for a motor vehicle is provided, with the engine comprising: a plurality of cylinders; at least one of the cylinders of the engine arranged as a dedicated exhaust gas recirculation (EGR) cylinder, wherein 90%-100% by volume of exhaust gas expelled from the dedicated EGR cylinder is recirculated to an intake system of the engine; a plurality of first fuel injectors to receive a first hydrocarbon fuel from a first fuel tank, wherein each of first fuel injectors is arranged to provide the first hydrocarbon fuel to one of the cylinders; and a second fuel injector to receive a second hydrocarbon fuel from a second fuel tank, wherein the second fuel injector is arranged to provide the second hydrocarbon fuel to the dedicated EGR cylinder.

### BRIEF DESCRIPTION OF THE DRAWINGS

The above-mentioned and other features of this disclosure, and the manner of attaining them, will become more apparent and better understood by reference to the following description of embodiments described herein taken in conjunction with the accompanying drawings, wherein:

FIG. 1 is a schematic representation of an internal combustion engine having an emissions system, particularly an EGR system. As shown, the engine may utilize fuel from two different fuel sources, and include an EGR apparatus comprising a water gas shift reactor according to a first embodiment of the present disclosure;

FIG. 2 is a graphical representation of the molar concentration of hydrogen (H₂) gas and carbon monoxide (CO) gas contained in exhaust gas from gasoline and natural gas (which may be either compressed natural gas (CNG) or liquefied natural gas (LNG)) at different equivalence ratios; and

FIG. 3 is a schematic representation of an internal combustion engine which may utilize fuel from two different sources, and include an EGR apparatus comprising a steam hydrocarbon reformer according to a second embodiment of the present disclosure.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

The following description is directed to various configurations of emissions systems, particularly exhaust gas recirculation (EGR) systems, apparatuses and methods to be used with an internal combustion engine, particularly of a motor vehicle such as an automobile. With an EGR system, one or more cylinders of the internal combustion engine may be used to generate exhaust gas, which may then be recirculated and mixed with an intake stream of fresh (ambient) air to provide a mixed charge (mixture) of exhaust gas and air to the cylinders of the engine.

For the purposes of this disclosure, an engine configured such that substantially an entire output of exhaust gas from a cylinder is to be recirculated for EGR may be referred to herein as an engine having a dedicated EGR cylinder.

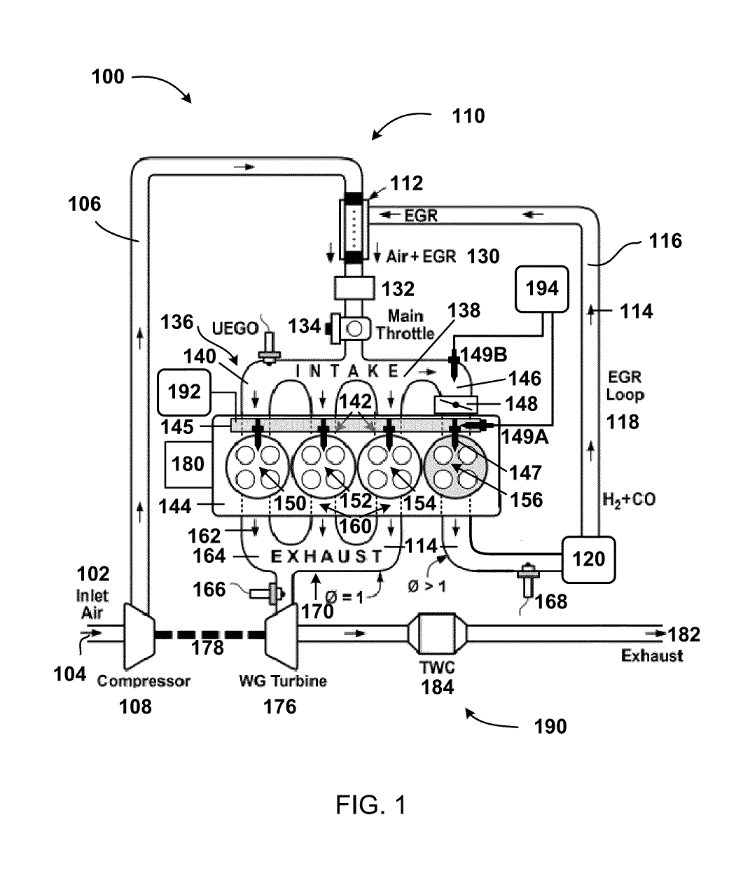

Referring now to the figures, FIG. 1 illustrates an internal combustion engine 100. Internal combustion engine 100 may power a motor vehicle that utilizes at least two hydrocarbon fuels which have different compositions. The first, or primary fuel, may be gasoline, which may comprise alkanes having four to twelve carbon atoms (e.g. butane (C₄H₁₀), pentane (C₅H₁₂), hexane (C₆H₁₄), heptane (C₇H₁₆), octane (C₈H₁₈), nonane (C₉H₂₀), decane (C₁₀H₂₂), undecane (C₁₁H₂₄) and dodecane (C₁₂H₂₆)). The second, or secondary fuel, may have a hydrogen to carbon (H:C) atomic ratio which is greater than that of the primary fuel. For example, gasoline may be understood to have a H:C ratio of about 1.86. In contrast, if secondary fuel is formed exclusively of methane (CH₄) or propane (C₃H₈), the secondary fuel may be understood to have a H:C atomic ratio of 4.0 or 2.67, respectively.

Secondary fuel may be natural gas, either as compressed natural gas (CNG) or liquefied natural gas (LNG). Natural gas may comprise 80%-99% methane (CH₄) gas, with liquefied natural gas (LNG) having more methane (CH₄) gas than compressed natural gas (CNG). Other components of natural gas may include ethane (C₂H₆), propane (C₃H₈), butane (C₄H₁₀), pentane (C₅H₁₂), nitrogen (N₂), carbon dioxide (CO), oxygen (O₂) and hydrogen (H₂). The secondary fuel may also be liquefied petroleum gas (LPG), such as liquefied propane (C₃H₈) and/or liquefied butane (C₄H₁₀).

As such, internal combustion engine 100 may be a dual fuel engine which is configured to operate with both gasoline and natural gas being used as fuels simultaneously.

Internal combustion engine 100 is shown to have four cylinders 150, 152, 154 and 156, although such is not intended to limit the present disclosure. One of the cylinders, cylinder 156, may be understood to be a dedicated EGR cylinder. In other words, it may be understood that substantially all of the exhaust gas 114 expelled from cylinder 156 may be directed (recirculated) back to the intake system 110, here through an EGR feedback loop 118. The exhaust gas from the remaining three cylinders 150, 152, and 154 is directed to an exhaust system 190, with none of the exhaust gas expelled from cylinders 150, 152 and 154 recirculated to the intake system 110 of engine 100.

While it may be possible, based on the configuration of engine 100, for all of the exhaust gas (i.e. 100%) expelled from cylinder 156 to be optimally recirculated back to the intake system 110, it should be understood that certain design considerations and operating inefficiencies may only allow a substantial portion of the exhaust gas expelled from cylinder 156 to be recirculated back to the intake system 110. For example, exhaust gas losses may occur between connection points. Accordingly, it is contemplated that on a volume basis, 90% or more of the exhaust gas expelled from the dedicated EGR cylinder is recirculated to the engine intake system 110. More preferably, 90-100% of the exhaust gas expelled from cylinder 156 is recirculated, including all values therein, in 0.1% by volume increments.

Furthermore, with four cylinders of equal volume, engine 100 may also be understood to have a nominal “25% dedicated EGR content” because the exhaust gas expelled from each cylinder may be understood to have substantially the same volume, and one of the four cylinders has 100% of its exhaust gas redirected to the intake system 110, as noted above. The actual EGR content can vary depending on differences in cylinder head pressure drop from cylinder to cylinder.

During an operation of engine 100, fresh (ambient) intake air 102 may enter air inlet 104 of air intake system 110. The air 102 may then travel within intake passage 106, during which time it may be compressed by intake compressor 108. Thereafter, air 102 may enter air/exhaust gas mixer 112 of air intake system 110, and more particularly as distribution mixer, which is configured to distribute and mix the recirculated and exhaust gas 114 into the stream of air 102 to be introduced to the internal combustion engine 100.

As shown by FIG. 1, each of cylinders 150, 152, 154 and 156 may receive the primary (first) hydrocarbon fuel, such as gasoline, from a fuel (common) rail 145 which is in fluid communication with a first fuel tank 192. Gasoline may be provided to each cylinder 150, 152, 154 and 156 from the fuel rail 145 by a direct fuel injector 147 located in each cylinder 150, 152, 154 and 156

In addition to the foregoing, dedicated EGR cylinder 156 may receive the secondary (second) hydrocarbon fuel, such as natural gas (compressed or liquefied) or liquefied petroleum gas, from a second fuel injector 149 in fluid communication with a second fuel tank 194. As shown, the second fuel injector 149A may be located in the intake port 142 of the cylinder head 144 (i.e. port fuel injection) dedicated to cylinder 156, or as shown at 149B in an intake passage 146 of the intake manifold 136 dedicated to cylinder 156. In either situation, the second fuel injector 149A or 149B is arranged to provide substantially all the fuel (90%-100% by volume) to the dedicated EGR cylinder 156, and not cylinders 150, 152 or 154. Thus, it may be understood that dedicated EGR cylinder 156 operates with a charge comprising the first hydrocarbon fuel, the second hydrocarbon fuel and the mixture of exhaust gas and air to the dedicated EGR cylinder, while the remaining cylinders are operated with a charge that does not include the second hydrocarbon fuel (i.e. 0% by volume) or includes such fuel only at a maximum level of up to 10% by volume.

Dedicated EGR cylinder 156 may be operated fuel rich (i.e. fuel-air equivalence ratio phi (Φ) is greater than 1.0) to produce exhaust gas 114 with carbon monoxide (CO) gas and hydrogen (H₂) gas which, may in turn, increase the octane number and promote increased EGR tolerance and knock tolerance by increasing flame/speed burn rates, as well as increasing the dilution limits of the mixture and associated combustion stability of all the cylinders.

It may be understood that the production of exhaust gas 114 with carbon monoxide (CO) gas and hydrogen (H₂) gas is the result of incomplete combustion of the fuel being provided to dedicated EGR cylinder 156, which may be expressed by the following reaction:

CₓH_{y}+zO₂→aCO₂+bCO+cH₂O+dH₂ (Eq 1)

While incomplete combustion of fuel in dedicated EGR cylinder 156, and the resultant production of carbon monoxide (CO) gas and hydrogen (H₂) gas, may be achieved by operating dedicated EGR cylinder 156 solely with the primary fuel such as gasoline, the concentration of hydrogen (H₂) gas in the exhaust gas 114 may be increased by operating dedicated EGR cylinder 156 with the secondary fuel, such as natural gas or petroleum gas, simultaneously with the primary fuel. As set forth above, the secondary fuel has a hydrogen to carbon (H:C) atomic ratio which is greater than that of the primary fuel and, consequently, provide higher levels of hydrogen (H₂) gas in the exhaust gas 114 than the primary fuel when used alone.

Alternatively, while incomplete combustion of fuel in dedicated EGR cylinder 156, and the resultant production of carbon monoxide (CO) gas and hydrogen (H₂) gas, may be achieved by operating dedicated EGR cylinder 156 solely with the secondary fuel, fuels such as natural gas or petroleum gas may be understood to have slower burning velocities, higher ignition energy requirements and reduced rich combustion limits. As such, while it is possible herein to operate dedicated EGR cylinder 156 solely with a secondary fuel such as natural gas or petroleum gas, the foregoing deficiencies encountered in doing such make it less desirable.

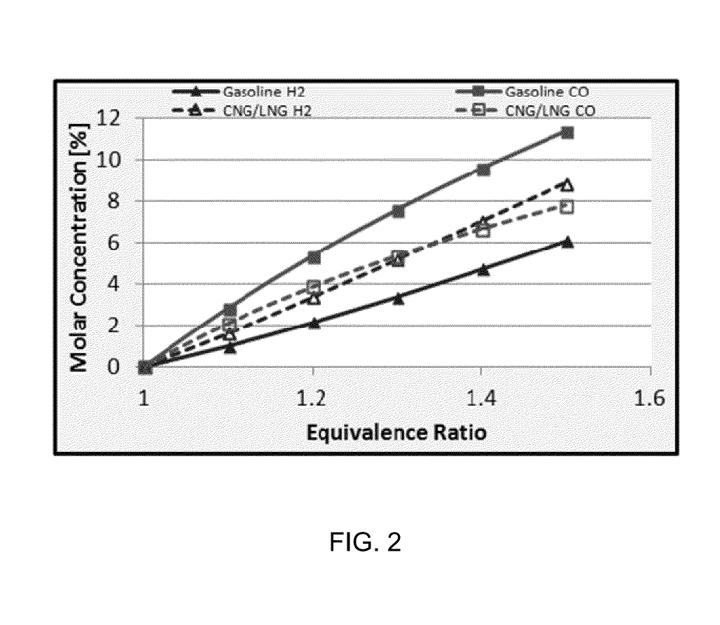

By using a dual fuel approach to provide exhaust gas enrichment to the dedicated EGR cylinder 156, it is possible to now make efficient use of the increased rich combustion limits of the primary fuel, such as gasoline, and the increased H:C ratio of the secondary fuel, such as natural gas or petroleum gas. Referring now to FIG. 2, FIG. 2 shows hydrogen (H₂) gas and carbon monoxide (CO) gas emissions as a function of the fuel-air equivalence ratio for both gasoline and natural gas (e.g. CNG or LNG) fuels. The higher H:C atomic ratio of the natural gas (CNG/LNG) results in a higher concentration of hydrogen (H₂) gas in the exhaust gas stream than with gasoline. Assuming constant adiabatic flame temperature, hydrogen (H₂) gas content present from the rich combustion of natural gas (CNG/LNG) is 50% higher than gasoline.

Now, while carbon monoxide (CO) gas production is 33% lower when natural gas (CNG/LNG) in used place of gasoline, and both hydrogen (H₂) gas and carbon monoxide (CO) gas have been shown to improve knock tolerance and combustion duration of dilute gasoline engines, the benefits of hydrogen (H₂) gas for both knock tolerance and combustion duration are observed to be much greater than carbon monoxide (CO) gas. Therefore, increasing hydrogen (H₂) gas concentration at the expense of a reduction in carbon monoxide (CO) gas concentration results in a net improvement in fuel efficiency of the dedicated EGR engine 100.

After exiting dedicated EGR cylinder 156, exhaust gas 114 from dedicated EGR cylinder 156 will enter passage 116 of EGR feedback loop 118. Thereafter, exhaust gas 114 will enter mixer 112 of the air intake system 110 and be mixed with a stream of air 102 to provide a mixture 130 of air 102 and exhaust gas 114. As explained herein, exhaust gas 114 from dedicated EGR cylinder 156 may be treated within the EGR feedback loop 118 after exiting EGR cylinder 156 and prior to mixing with air 102.

To further increase the quantity of hydrogen (H₂) gas in exhaust gas 114 after leaving the dedicated EGR cylinder 156, prior to entering mixer 112 the untreated exhaust gas 114 may enter a water gas shift reactor 120 within the EGR feedback loop 118. Upon entering the water gas shift reactor 120, one or more components of the exhaust gas 114 may react with water (H₂O) vapor using a water gas shift reaction (WGSR) with a suitable water gas shift (WGS) catalyst contained in a water gas shift reactor 120. More particularly, with the WGS reaction, carbon monoxide (CO) gas in the exhaust gas 114 may react with water (H₂O) vapor to produce carbon dioxide (CO₂) gas and hydrogen (H₂) gas according to the following reaction:

CO+H₂O→CO₂+H₂ (Eq 2)

Reacting carbon monoxide (CO) gas in the exhaust gas 114 with water (H₂O) vapor to produce hydrogen (H₂) gas is beneficial by increasing the amount of hydrogen (H₂) gas in the exhaust gas 114 from dedicated EGR cylinder 156. The WGS catalyst performance is highly dependent on exhaust temperature, and the amount of hydrogen (H₂) gas exiting the WGS catalyst is dependent on the amount entering and the amount created. The amount of hydrogen (H₂) gas entering the WGS catalyst is a function of the fuel, the dedicated EGR cylinder air/fuel ratio and spark timing. The amount of hydrogen (H₂) gas created is therefore dependent on exhaust gas temperature and the amount of carbon monoxide (CO) gas in the inlet exhaust. It is possible to manipulate both with the dedicated EGR cylinder air/fuel ratio. Therefore, for a given operating condition, the dedicated EGR cylinder air/fuel ratio may be controlled to increase the amount of hydrogen (H₂) gas exiting the WGS catalyst. Examples of WGS catalysts may include iron oxides (Fe₃O₄) or other transition metals and transition metal oxides.

After being mixed in mixer 112, air/exhaust gas mixture 130 may then flow in passage 106 to cooler 132 (e.g. heat exchanger) to remove heat therefrom and correspondingly increase the density thereof. In the cooler 132, the air/exhaust gas mixture 130 is preferably cooled to a temperature in a range of 30° C. to 60° C.

After being cooled by cooler 132, air/exhaust gas mixture 130 may then flow to an intake flow restrictor 134, such as an intake throttle valve (a mechanism by which a flow of the air/exhaust gas mixture 130 is managed by restriction or obstruction) configured to restrict the volumetric flow and amount (mass) of air/exhaust gas mixture 130 provided to cylinders 150, 152, 154 and 156. The intake throttle valve may more particularly comprise a butterfly valve that restricts the flow and amount of air/exhaust gas mixture 130 entering the intake manifold 136 and ultimately provided to cylinders 150, 152, 154 and 156. Intake flow restrictor 134 may be considered to be a primary flow restrictor in that it may similarly restrict the flow of the air/exhaust gas mixture 130 to all of cylinders 150, 152, 154 and 156.

Intake flow restrictor 134 may be located at the entrance of intake manifold 136. Intake manifold 136 may comprise a plenum 138 through which the air/exhaust gas mixture 130 may flow to a plurality of intake passages/runners 140, shown with one passage/runner 140 dedicated to each cylinder 150-156. Each passage/runner 140 may then feed the air/exhaust gas mixture 130 directly into an intake port 142 (shown by dotted lines) of a cylinder head 144, shown with one port 142 dedicated to each cylinder 150-156.

After entering cylinders 150-156, the air/exhaust gas mixture 130 may be ignited by an igniter (not shown) and combust therein. After combustion of the air/exhaust gas mixture 130 within cylinders 150-156, untreated exhaust gas 114 from cylinders 150, 152 and 154 may flow through exhaust ports 160 of cylinder head 144 and exhaust passages/runners 162 of exhaust manifold 170, shown with exhaust ports 160 and one passage/runner 162 dedicated to each cylinder 150-154, and then be collected in collector 164.

From collector 164, untreated exhaust gas 114 may then flow through turbine 176, which may turn intake compressor 108 by shaft 178. After turbine 176, untreated exhaust gas 114 may flow through exhaust passage 182 to catalytic converter 184 to be treated therein before being expelled from exhaust system 190 and into the atmosphere. Catalytic converter 184 may comprise a three-way catalytic converter (TWC). In other words, a catalytic converter which performs the following:

(1) reduction of nitrogen oxides to nitrogen and oxygen by the reaction:

2NOₓ→xO₂+N₂ (Eq 3)

(2) oxidation of carbon monoxide to carbon dioxide by the reaction:

2CO+O₂→2CO₂ (Eq 4)

(3) oxidation of unburnt hydrocarbons (HC) to carbon dioxide and water by the reaction:

$${C}_{x} {H}_{2 x + 2} + [ \frac{3 x + 1}{2} ] {O}_{2} -> x {CO}_{2} + ( x + 1 ) {H}_{2} O \qquad ( Eq 5 )$$

To control the air/fuel ratio, untreated exhaust gas 114 from cylinders 150, 152 and 154 may be sampled by an exhaust gas oxygen (EGO) sensor 166, which may more particularly comprise a heated exhaust gas oxygen (HEGO) sensor, while untreated exhaust gas 114 from cylinder 156 may be sampled by an exhaust gas oxygen (EGO) sensor 168, which may more particularly comprise a universal exhaust gas oxygen (UEGO) sensor.

To control the mass and volumetric flow rate of the air/exhaust gas mixture 130 entering dedicated EGR cylinder 156, the portion of the intake passage 146 dedicated to cylinder 156 may include an intake charge flow restrictor 148, such as a throttle valve, configured and arranged to restrict the flow and amount of air/exhaust gas mixture 130 entering cylinder 156 without restricting the flow and amount of air/exhaust gas mixture 130 entering remaining cylinders 150, 152 or 154. The throttle may more particularly comprise a butterfly valve that restricts the amount of air/exhaust gas mixture 130 entering cylinder 156.

Flow restrictor 148 may be considered to be a secondary flow restrictor in that it may restrict the flow of the air/exhaust gas mixture 130 to a particular cylinder, here cylinder 156, as opposed to all the cylinders, after the air/exhaust gas mixture 130 has flowed past primary flow restrictor 134. Flow restrictor 148 may be used in conjunction with intake/exhaust valves, fuel injectors and engine controller 180 of engine 100 to operate or otherwise control dedicated EGR cylinder 156 at the same or different air/fuel ratio than cylinders 150, 152 and 154. Further, each cylinder 150-156 may be independently operated at an air/fuel ratio which is greater than (rich), equal to, or less than (lean) a stoichiometric ratio for the air and fuel.

As shown in FIG. 1, flow restrictor 148 may be located on the intake side of cylinder 156 for intake restriction. Flow restrictor 148 may be attached to the intake manifold 136, or arranged between the intake manifold 136 and the cylinder head 144.

As flow restrictor 148 may be at least partially closed, the flow and amount of air/exhaust gas mixture 130 entering cylinder 156 may be decreased. Simultaneously, the air/exhaust gas mixture 130 entering cylinders 150, 152 and 154 may be increased, provided flow restrictor 134 remains unchanged. Thus, the flow and amount of the air/exhaust gas mixture 130 entering cylinder 156 may be inversely related to the flow and amount of the air/exhaust gas mixture 130 entering cylinders 150, 152 and 154. That is, as the flow and amount of the air/exhaust gas mixture 130 entering cylinder 156 may be decreased, the flow and amount of the air/exhaust gas mixture 130 entering cylinders 150, 152 and 154 may be increased, and vice-versa.

As indicated above, without the use of flow restrictor 148, the engine 100 in FIG. 1 may be understood to have a maximum “25% dedicated EGR content” because the exhaust gas expelled from each cylinder 150-156 may be understood to have substantially the same volume, and one of the four cylinders, cylinder 156, has 90-100% by volume of its exhaust gas redirected to the intake manifold 136.

However, with the use of flow restrictor 148, the volume of exhaust gas expelled from cylinder 156 may now be varied by restricting the amount of air/exhaust gas 130 which is consumed by cylinder 156 such as the engine 100 may provide, for example, between 0.1% and 25% dedicated EGR. By decreasing the flow and amount of air/exhaust gas 130 which is consumed by cylinder 156, the flow and amount of untreated exhaust gas 114 expelled from cylinder 156 and routed/processed through EGR loop 118 to air intake system 110 may be correspondingly decreased, which will decrease the amount of treated exhaust gas 114 provided to the cylinders 150, 152, 154 and 156. Restriction of untreated exhaust gas 114 expelled from cylinder 156 may be particularly necessary if the quantity of treated exhaust gas 114 adversely effects engine performance.

If dedicated EGR cylinder 156 is operated fuel rich, particularly with use of the secondary fuel, and/or exhaust gas 114 is processed through water gas shift (WGS) catalyst, a relatively significant amount of hydrogen (H₂) gas and carbon monoxide (CO) gas may be formed, both of which may promote increased EGR tolerance by increasing burn rates, increasing the dilution limits of the mixture and reducing quench distances. In addition, the engine 100 may perform better at knock limited conditions, such as improving low speed peak torque results, due to increased EGR tolerance and the knock resistance provided by hydrogen (H₂) and carbon monoxide (CO). Also, while the EGR tolerance of the engine 100 may now increase, the overall fuel consumption may decrease.

While a water gas shift catalyst may result in production of hydrogen (H₂) gas, the water-gas shift catalyst exchanges carbon monoxide (CO) gas for hydrogen (H₂) gas and carbon dioxide (CO₂) gas, meaning that any hydrogen (H₂) gas produced results in a loss of combustible carbon monoxide (CO) gas and a gain of incombustible carbon dioxide (CO₂) gas, which does not provide the same level of combustion benefit as hydrogen (H₂).

Furthermore, the water-gas shift reaction is mildly exothermic, meaning energy is released as the reaction progresses, and thus energy is lost through the process. More particularly, for an engine system with a traditional low level EGR loop, a heat exchanger is generally utilized to reduce the temperature of the EGR feed prior to mixing with intake air. This heat is typically rejected to the engine coolant, and is then subsequently rejected to the ambient environment via the radiator. Similarly, in a gasoline D-EGR application, the energy released during the exothermic water-gas shift reaction is rejected via the same process, meaning that the energy produced by the reaction is not used in a useful manner. As a result, it may be understood that the energy content of hydrogen (H₂) gas created is slightly less than the energy content of the carbon monoxide (CO) gas consumed.

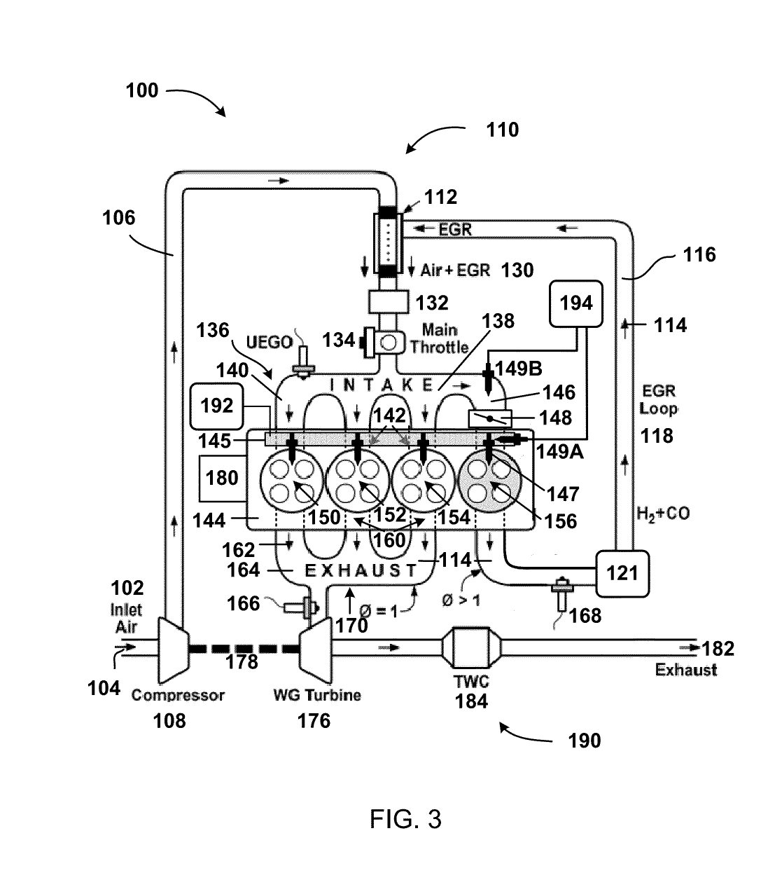

Alternatively, in another embodiment as shown in FIG. 3, to increase the quantity of hydrogen (H₂) gas in exhaust gas 114 after leaving the dedicated EGR cylinder 156, prior to entering mixer 112 the untreated exhaust gas 114 may enter a steam hydrocarbon reformer 121 within the EGR feedback loop 118. Upon entering the steam hydrocarbon reformer 121, one or more components of the exhaust gas 114 may react with water (H₂O) vapor using a steam reformation reaction (SRR) with a suitable steam reformation (SR) catalyst. More particularly, with the SRR reaction, hydrocarbons (HC) which may exist in the exhaust gas 114 after passing through dedicated EGR cylinder 156, particularly due to the dedicated EGR cylinder 156 being operated fuel rich (i.e. phi (4) is greater than 1.0), may react with water (H₂O) vapor to produce carbon monoxide (CO) gas and hydrogen (H₂) gas according to the following reaction:

CₙHₘ+nH₂O→nCO+(n+m/2)H₂ (Eq 6)

As shown above, use of a steam reformation reaction with a steam reformation catalyst contained in steam hydrocarbon reformer 121 simultaneously produces carbon monoxide (CO) gas and hydrogen (H₂) gas from unburnt hydrocarbon (HC) gas and water vapor in the untreated exhaust gas 114. Thus, reacting a hydrocarbon (HC) gas and water vapor in the untreated exhaust gas 114 from dedicated EGR cylinder 156 to produce carbon monoxide (CO) gas and hydrogen (H₂) gas is beneficial by increasing the amount of carbon monoxide (CO) gas and hydrogen (H₂) gas in the untreated exhaust gas 114 from dedicated EGR cylinder 156.

The steam reformation catalyst may comprise nickel (Ni) as the active metal. For example, the steam reformation catalyst may comprise a Ni-M composition, where M=gold (Au), silver (Ag), tin (Sn), copper (Cu), cobalt (Co), molybdenum (Mo), iron (Fe), gadolinium (Gd) or boron (B). Apart from such Ni-M compositions, one may also use palladium (Pd) or platinum (Pt) as the steam reformation catalyst. A particularly preferred catalyst is nickel or palladium. Preferably, the steam reformation reaction is carried out at temperatures at or above 500° C.

Untreated exhaust gas 114 entering steam hydrocarbon reformer 121 preferably may have a temperature in a range of 400° C. to 800° C., and be exposed to a pressure in a range of 14.7 psia to 44 psia. It is generally desirable to maintain exhaust temperatures as high as possible to increase production of carbon monoxide (CO) gas and hydrogen (H₂) gas from a hydrocarbon (HC) gas. As such, for D-EGR applications, one particular placement of the steam hydrocarbon reformer 121 is as close to the exhaust port 160 as possible, so that the temperature of the exhaust gas 114 entering the steam hydrocarbon reformer 121 is as high as possible.

The amount of unburned hydrocarbon (HC) gas from dedicated EGR cylinder 156, as well as the amount of carbon monoxide (CO) gas and hydrogen (H₂) gas created in dedicated EGR cylinder 156, and subsequently entering the steam hydrocarbon reformer 120 is a function of the dedicated EGR cylinder air/fuel ratio and spark timing. For example, if dedicated EGR cylinder 156 is operated fuel rich of stoichiometric A/F (air/fuel) ratio, a relatively significant amount of carbon monoxide (CO) and hydrogen (H₂) may be formed prior to the use of the hydrocarbon reformer 121.

The amount of carbon monoxide (CO) gas and hydrogen (H₂) gas further created in the hydrocarbon reformer 121 is dependent on exhaust gas temperature and the amount of hydrocarbon or methane (CH₄) gas in the untreated exhaust gas 114 entering the reformer 121. Thus, performance of the steam reformation catalyst is dependent on exhaust gas temperature, with the amount of carbon monoxide (CO) gas and hydrogen (H₂) gas exiting the steam hydrocarbon reformer 121 being dependent on the amount existing prior to use of the steam hydrocarbon reformer 121 and the amount created in the steam hydrocarbon reformer 121.

Given that the hydrocarbon steam reformation reaction produces carbon monoxide (CO) gas and hydrogen (H₂) gas simultaneously, which are both combustible, the benefits of carbon monoxide (CO) gas and hydrogen (H₂) gas with respect to octane number and burning velocity can be realized from the steam reformation reaction. Generation of both carbon monoxide (CO) gas and hydrogen (H₂) gas for the EGR stream may be understood to have a positive impact on the charge properties of the EGR stream. More particularly, the combination and co-existence of carbon monoxide (CO) gas and hydrogen (H₂) gas in the EGR stream may improve flame speed and combustion stability, as well as improve knock and EGR tolerance.

Furthermore, the steam reformation reaction is endothermic, meaning energy is put into the reaction and thus the heating value (or energy content) of the formed carbon monoxide (CO) gas and hydrogen (H₂) gas mixture is greater than the heating value of the consumed methane (CH₄) gas. Stated another way, since the hydrocarbon steam reformation reaction is endothermic, waste heat energy (from the exhaust gas) is used to produce carbon monoxide (CO) gas and hydrogen (H₂) gas from hydrocarbons, thereby increasing the final energy content of the mixture. Essentially, the steam reformation catalyst functions as a chemical waste heat recuperative device, which makes use of exhaust energy (that would otherwise be rejected to the environment) in order to increase the energy content of the fuel.

For operation of steam reformation catalysts in an environment containing appreciable amounts of sulfur which may poison the catalyst, it may be necessary to utilize a regenerable or replaceable sulfur trap upstream of the steam reformation catalyst in order prevent sulfation of the steam reformation catalyst. Natural gas streams are typically very free of sulfur, and as such may allow for effective use of regenerable or replaceable sulfur traps with satisfactory replacement or regeneration intervals.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A method of operating an internal combustion engine having a plurality of cylinders, the method comprising:
operating the engine with at least one of the cylinders of the engine as a dedicated exhaust gas recirculation (EGR) cylinder, wherein 90%-100% by volume of exhaust gas expelled from the dedicated EGR cylinder is recirculated to an intake system of the engine;
mixing exhaust gas expelled from the dedicate EGR cylinder with air in the intake system of the engine to provide a mixture of exhaust gas and air;
providing a first hydrocarbon fuel from a first fuel tank;
providing a second hydrocarbon fuel from a second fuel tank;
introducing a charge comprising the first hydrocarbon fuel, the second hydrocarbon fuel and the mixture of exhaust gas and air to the dedicated EGR cylinder;
igniting the charge in the dedicated EGR cylinder;
expelling exhaust gas from the dedicated EGR cylinder; and
recirculating the exhaust gas to the intake system of the engine.

2. The method of claim 1 wherein:
the second hydrocarbon fuel has a hydrogen to carbon (H:C) atomic ratio greater than the first hydrocarbon fuel.

3. The method of claim 2 wherein:
the first hydrocarbon fuel is gasoline.

4. The method of claim 2 wherein:
the second hydrocarbon fuel is natural gas.

5. The method of claim 2 wherein:
the second hydrocarbon fuel is liquefied petroleum gas.

6. The method of claim 1 wherein:
the second hydrocarbon fuel is added to the charge by a fuel injector located in an intake manifold of the engine or intake port of the engine.

7. The method of claim 1 further comprising:
introducing a charge comprising the first hydrocarbon fuel and the mixture of exhaust gas and air to each of the remaining cylinders; and
wherein the charge introduced to each of the remaining cylinders does not include the second hydrocarbon fuel.

8. The method of claim 1 further comprising:
igniting the charge in each of the remaining cylinders;
expelling exhaust gas from each of the remaining cylinders; and
treating the exhaust gas expelled from each of the remaining cylinders with a catalytic converter.

9. The method of claim 1 wherein:
during the step of recirculating the exhaust gas to the intake system of the engine, the exhaust gas is routed through a water gas shift reactor that converts carbon monoxide and water to carbon dioxide and hydrogen; and
the exhaust gas undergoes a reaction in the water gas shift reactor, wherein the reaction increases a quantity of hydrogen contained in the exhaust gas.

10. The method of claim 1 wherein:
during the step of recirculating the exhaust gas to the intake system of the engine, the exhaust gas is routed through a steam hydrocarbon reformer that converts hydrocarbon and water to carbon monoxide and hydrogen; and
the exhaust gas undergoes a reaction in the steam hydrocarbon reformer, wherein the reaction increases a quantity of carbon monoxide and hydrogen contained in the exhaust gas.

11. An internal combustion engine, the engine comprising:
a plurality of cylinders;
at least one of the cylinders of the engine arranged as a dedicated exhaust gas recirculation (EGR) cylinder, wherein 90%-100% by volume of exhaust gas expelled from the dedicate EGR cylinder is recirculated to an intake system of the engine;
a plurality of first fuel injectors to receive a first hydrocarbon fuel from a first fuel tank, wherein each of first fuel injectors is arranged to provide the first hydrocarbon fuel to one of the cylinders; and
a second fuel injector to receive a second hydrocarbon fuel from a second fuel tank, wherein the second fuel injector is arranged to provide the second hydrocarbon fuel to the dedicated EGR cylinder.

12. The internal combustion engine of claim 11 wherein:
the engine is arranged such that the second hydrocarbon fuel is only provided to the dedicated EGR cylinder and not the remaining cylinders.

13. The internal combustion engine of claim 11 wherein:
the exhaust gas expelled from the dedicate EGR cylinder is recirculated to the intake system of the engine in an EGR feedback loop; and
the engine further comprises a water gas shift reactor located in the EGR feedback loop to convert carbon monoxide and water to carbon dioxide and hydrogen such that the exhaust gas expelled from the dedicated EGR cylinder is routed through the water gas shift reactor.

14. The internal combustion engine of claim 11 wherein:
the exhaust gas expelled from the dedicated EGR cylinder is recirculated to the intake system of the engine in an EGR feedback loop; and
the engine further comprises a steam hydrocarbon reformer located in the EGR feedback loop to convert hydrocarbon and water to carbon monoxide and hydrogen such that the exhaust gas expelled from the dedicated EGR cylinder is routed through the steam hydrocarbon reformer.

15. The internal combustion engine of claim 11 wherein:
the first fuel injectors are arranged to direct the first fuel directly into each cylinder.

16. The internal combustion engine of claim 11 wherein:
the second fuel injector is arranged in an intake port of the dedicated EGR cylinder and/or an intake passage of the dedicated EGR cylinder.

17. The internal combustion engine of claim 16 wherein:
the intake port is within a cylinder head of the engine.

18. The internal combustion engine of claim 16 wherein:
the intake passage is located within an intake manifold of the engine.

19. The internal combustion engine of claim 11 wherein:
the first fuel tank is a gasoline fuel tank and the second fuel tank is a natural gas fuel tank or a liquefied petroleum gas fuel tank.

20. A motor vehicle comprising:
an internal combustion engine having a plurality of cylinders;
at least one of the cylinders of the engine arranged as a dedicated exhaust gas recirculation (EGR) cylinder, wherein 90%-100% by volume of exhaust gas expelled from the dedicated EGR cylinder is recirculated to an intake system of the engine;
a plurality of first fuel injectors to receive a first hydrocarbon fuel from a first fuel tank of the motor vehicle, wherein each of first fuel injectors is arranged to provide the first hydrocarbon fuel to one of each of the cylinders; and
a second fuel injector to receive a second hydrocarbon fuel from a second fuel tank of the motor vehicle, wherein the second fuel injector is arranged to provide the second hydrocarbon fuel to the dedicated EGR cylinder.
